(19) United States
(12) Patent Application Publication
(10) Pub. No.: US 2014/0116942 A1
(43) Pub. Date: May 1, 2014

(54) AIR FLOTATION AND ELECTROCOAGULATION SYSTEM

(71) Applicant: CAVITATION TECHNOLOGIES, INC., CHATSWORTH, CA (US)

(72) Inventors: Roman Gordon, Studio City, CA (US); Igor Gorodnitsky, Marina del Rey, CA (US); Maxim A. Promtov, Tambov (RU)

(73) Assignee: CAVITATION TECHNOLOGIES, INC., CHATSWORTH, CA (US)

(21) Appl. No.: 14/149,639

(22) Filed: Jan. 7, 2014

Related U.S. Application Data
(63) Continuation-in-part of application No. 12/976,253, filed on Dec. 22, 2010, now Pat. No. 8,673,129.

(51) Int. Cl. C02F 1/463; C02F 9/00; C02F 1/24

(52) U.S. Cl. CPC C02F 1/463; C02F 1/24; C02F 9/00
USPC 210/638; 204/275.1; 210/205; 210/202; 210/200; 210/201; 210/703

(57) ABSTRACT

The invention relates to apparatuses, systems, and methods for the treatment of contaminated fluids, in particular water. The system is generally a continuous flow system including a multi-stage cavitation device, an electrocoagulation device, and an air flotation unit. The electrocoagulation device includes a plurality of interweaved cathode and anode plates. The anode plates are coated with an oxygen generating mixed-metal oxide coating. The air flotation unit includes a cavitation aerator and electrode blocks to introduce air bubbles into the fluid. Contaminants attach to the air bubbles and float to the fluid surface where they are removed as sludge. Treated fluid is passed through a final filtration system. The methods involve the processes imparted by the various apparatuses on the fluid.

### BACKGROUND OF THE INVENTION

The invention relates to a system and method for purification and treatment of potable water, ground water, industrial water, sewage water, etc. and finds numerous applications in drinking water production, food, chemical, oil, energy, wood, pulp and paper industries, mining and metal-processing and similar industries. Removable contaminants include metals, petroleum products, colloidal particles, living species, organics, dyes, polymers, surface-active compounds and other matter whose concentration can be decreased to the allowable levels in one pass through the present apparatus. The proposed water treatment method and the device generate changes in the fluidic flow's velocity, pressure, temperature, voltage, resistance and chemical composition and physical properties in order to reduce the concentration of impurities. The simultaneous action of hydrodynamic cavitation, electrocoagulation and the coagulants and active chemical species formed in situ provide a unique synergistic effect that results in a highly efficient purification process.

The electrocoagulation-based treatment of water, including purification of industrial waste water and sewage water, is based on using consumable sacrificial aluminum or iron anodes to release Al³⁺ or Fe²⁺ ions in the water:

Al→Al³⁺+3e⁻ or Fe→Fe²⁺+2e⁻. (1)

When the water containing colloidal particles, oil, biological species, metals or other contaminants passes through an applied electric field, the water and its constituents undergo ionization, electrolysis, hydrolysis, seeding, de-emulsifying, halogen complex formation, oxidation, bleaching, etc., all of which results in the formation of radicals. The anode metal ions initiate coagulation by neutralizing the electrostatic charges on suspended solid particles, oil droplets and microorganisms followed by removal of undesirable contaminants via co-precipitation, coalescence or coagulation and separation of flock and debris by flotation, filtration or other techniques. The electrocoagulation treatment prompts precipitation of certain metals, depending on the anode material, pH and other conditions.

The primary reaction that occurs on the cathode surface is:

2H₂O+2e⁻→H₂+2OH⁻. (2)

With an aluminum anode the overall reaction is:

2Al+6H₂O→2Al(OH)₃+3H₂, (3)

such that the aluminum hydroxide precipitates out.

With an iron anode, the dissolved oxygen is evolved due to the following electrochemical reactions:

2H₂O→O₂+4H⁺+4e⁻; and

2OH⁻→O₂+2H⁺+4e⁻ (4)

which rapidly oxidizes the released Fe²⁺ ions to Fe³⁺ ions according to the following reaction:

4Fe²⁺+O₂+4H⁺→4Fe³⁺+2H₂O, (5)

followed by the precipitation of insoluble ferric hydroxide in the following:

Fe³⁺+3OH⁻→Fe(OH)₃. (6)

The released anode metal ions can either react directly with negatively charged contaminants or contaminants can be removed by adsorption on the aluminum or ferric hydroxide precipitates. The iron anode reaction shifts the pH value toward more basic values and the electrochemical reactions decrease the pH value. Taking into account the overall electrochemical reactions, formation of various by-products and ion exchange one should expect more neutral pH values with the electrocoagulation treatment than with a conventional chemical coagulation procedure.

The amount of sacrificial anode metal to be dissolved during the electrocoagulation can be calculated by using Faraday's law: m=ltM/zF, where m is the amount of the dissolved anode material (g), l is the current (A), t is the electrolysis time (s), M is the molecular weight (g/mol), z is the number of electrons involved in the electrochemical reaction, and F is the Faraday's constant (9.648×10⁴ A·s/mol). Other conditions being equal, the electrocoagulation outcome is affected mainly by the current density, conductivity, pH, temperature, treatment time and anode material. (Barrera-Diaz, et al., 2006; Bazrafshan et al., 2008; Heidmann et al., 2008; Gu et al., 2009.)

Electrocoagulation has a number of advantages over conventional chemical coagulation. Commonly used chemical coagulants in the treatment of wastewater prior to its disposal and in the reuse of wastewater include KAl(SO₄)₂.12H₂O and FeCl₃.6H₂O. The chemical coagulants introduce substantial amounts of anions and acidic species along with metal cations, are characterized by a low concentration of the coagulants and, therefore, require the usage of large quantities of salts. For example, 1,000 kg KAl(SO₄)₂.12H₂O contain only 51.7 kg (5.17%) of Al³⁺.

Another important advantage of electrocoagulation compared to chemical coagulation is the compactness of the related equipment and the relative simplicity of its handling and operation. (Gu et al., 2009; Canizares et al., 2009.) Electrocoagulation apparatuses can be single-flow, multi-flow or hybrid-type devices. Usually, the electrodes are placed 5-20 mm apart and separated with insulating inserts to prevent circuit faults. In a single-flow device, fluid under treatment passes through a passage formed by a network of the interelectrode channels. In a multi-flow device, multiple fluidic flows move simultaneously through the parallel interelectrode channels. The direction of fluidic flow can be horizontal or vertical. The flow directed from the bottom up is preferred because it facilitates the removal of gases and solid particles formed during the electrocoagulation process. Electrocoagulation consumes 3-12 watt-hour per gram of the dissolved anode metal. In practice, power consumption is higher due to heating water, electrode polarization, oxide film formation and other processes. Therefore, the electrode surfaces and the interelectrode zones are periodically cleaned of debris with proper mechanical tools.

Cavitation can be of many origins, including acoustic, hydrodynamic, laser-induced or generated by injecting steam into a cool fluid. Acoustic cavitation requires a batch environment and cannot be used efficiently in continuous processing, because energy density and residence time would be insufficient for a high-throughput. In addition, the effect of acoustic cavitation diminishes with an increase in distance from the radiation source. Treatment efficacy also depends on container size as alterations in the fluid occurs at particular locations, depending on the acoustic frequency and interference patterns.

When a fluid is fed in a flow-through hydrodynamic cavitation device at a proper velocity, cavitation bubbles form as a result of the decrease in hydrostatic pressure inside the specially designed passages. When the cavitation bubbles transition into a slow-velocity, high-pressure zone, they implode. Such implosion is accompanied by a localized increase in both pressure and temperature, up to 1,000 atm and 5,000° C., and results in the generation of local jet streams, shock waves and shearing forces. The release of a significant amount of energy activates atoms, ions, molecules and radicals located in the bubbles and/or the adjacent fluid and drives chemical reactions and processes. The bubble implosion can be coincidental with the emission of light, which catalyzes photochemical reactions. (Suslick, 1989; Didenko et al., 1999; Suslick et al., 1999; Young, 1999; Gogate, 2008; Mahulkar et al., 2008; Zhang et al., 2008.)

U.S. Patent Applications Publication Nos. 2006/0081541 (Kozyuk) and 2007/0102371 (Bhalchandra et al.), and U.S. Pat. Nos. 5,393,417 and 5,326,468 to Cox and No. 4990260 to Pisani et al. disclose methods and apparatuses that use cavitation for the treatment and purification of water and other fluids.

U.S. Pat. No. 6,325,916 to Lambert and Kresnyak discloses a method and apparatus for removing contaminants from water that uses hydraulic cavitation treatment of contaminated water following the oxidation of water contaminants with a gaseous oxidant. The cavitation generates foam that transports a flock in a separate phase. The process may be augmented by electrocoagulation. By placing an electric cell within the reservoir with the water under treatment and exposing the electrodes to a current source, the contaminants within the aqueous medium are oxidized or degraded and this complements the oxidation by the dissolved gaseous oxidant.

Russian Patent No. 2316481 to Sister describes a method of purification of waste water from surface-active substances, in which the water is subjected to ultrasonic cavitation at a sound radiation intensity of 1.5-3 W/cm². Then the electrode set is connected to a DC source and an ultrasound and electrocoagulation are applied simultaneously at the ultrasound intensity of 1.2 W/cm² with a subsequent purification of wastewater with electrocoagulation. All stages of this water treatment are carried out in one electrochemical reactor.

The known methods of water purification that employ both electrocoagulation and cavitation use them in a periodic manner, which reduces the process output, and requires using rather complex equipment.

### SUMMARY OF THE INVENTION

The invention discloses a method and device for the efficient purification of water and other fluids from contaminants, the method and device being based on the simultaneous actions of both hydrodynamic cavitation and electrocoagulation. In the method, a fluid flow moves through narrow passages between adjacent electrodes with a non-flat or patterned surface. The fluid flow moves at a high rate to generate hydrodynamic cavitation features in the fluid flow.

The method for water treatment comprises the simultaneous application of flow-through hydrodynamic cavitation and electrocoagulation to a contaminated fluid flow. Preferably, the fluid is subjected to hydrodynamic cavitation on its own prior to the simultaneous application of hydrodynamic cavitation and electrocoagulation. The hydrodynamic cavitation is preferably a high-throughput process.

The reactor in which the fluid flow is subject to hydrodynamic cavitation and electrocoagulation comprises an inlet sleeve provided with channels having both constrictions and expansions. The channels are preferably shaped as Venturi tubes. The reactor includes contact surfaces on a hollow cathode and an inner cylindrical anode. The contact surfaces are provided with ring-type patterned features or protuberances. The patterned contact surfaces preferably include electrode superficial patterns comprising threads or right triangles. The electrode surface patterns may also comprise rectangular triangle cross-sections having a long leg parallel to the electrode axis and a short leg perpendicular to the electrode axis. The angle between the large leg and the hypotenuse of the rectangular triangle is preferably between fifteen degrees and sixty degrees. The distance between the nearest points on neighboring protuberances (L1) and the length of the large leg (L2) (FIG. 3b) preferably has a ratio of between zero and ten (L1/L2 is less than or equal to 10).

Accordingly, besides the objects and advantages of the high-speed fluid upgrading described herein, several objects and advantages of the present inventions are:
To provide a method that provides a high-throughput combined with a high efficiency of water purification.
To provide a method that does not require periodic shutdown of the unit for electrode surface cleaning.
To provide a method that allows simultaneous action of hydrodynamic cavitation, electrolysis and in situ coagulation to bring about a synergistic effect that results in a highly efficient purification.
To provide a compact apparatus, in which cavitation deactivates harmful microorganisms, creates vigorous mixing conditions and facilitates destruction and oxidation of contaminants by the electrocoagulation-generated active species.
To provide an apparatus that promptly generates changes in a fluid flow's velocity, pressure, temperature, voltage, resistance and chemical composition and properties.

The present invention is directed to a fluid treatment system configured for essentially continuous operation. The system includes a pump, a multi-stage cavitation device, an electrocoagulation device, and an air flotation unit. The pump is configured to force a contaminated fluid through the system. The multi-stage cavitation system is fluidly connected to a fluid discharge from the pump. The multi-stage cavitation system may include a plurality of multi-stage cavitation devices, connected in series or in parallel. The electrocoagulation device is fluidly connected to a fluid outlet from the multi-stage cavitation system. The air flotation unit is fluidly connected to a fluid outlet from the electrocoagulation device.

The system may further include a receiving tank configured to receive and store fluid for treatment. The receiving tank is disposed upstream of the pump and fluidly connected to a fluid inlet on the pump. A self-cleaning filter may be fluidly connected to the fluid discharge from the pump and configured to pass filtered contaminated fluid to the multi-stage cavitation system. A final filter tank may be fluidly connected to a treated fluid outlet from the air flotation unit. The final filter tank may be a mineral/resin tank or a membrane filter tank. A filter press may be fluidly connected to a sludge discharge from the air flotation unit and a fluid outlet from the filter press fluidly connected to the final filter tank.

The electrocoagulation device preferably includes a plurality of alternating cathode and anode plates made from titanium. The anode plates are preferably non-sacrificial and include a mixed-metal oxide coating, such as a mixture of iridium oxide and tantalum oxide.

The air flotation unit preferably includes an electrode block, the electrode block comprising a plurality of alternating cathode and anode plates made from titanium. The anode plates are preferably non-sacrificial and include a mixed-metal oxide coating, such as a mixture of iridium oxide and tantalum oxide.

In a particularly preferred embodiment, the electrocoagulation device may include an enclosed housing having a fluid inlet and a fluid outlet. A plurality of alternating cathode plates and anode plates are disposed between the fluid inlet and the fluid outlet. An electrical source is connected on a first side to the cathode plates and on a second side to the anode plates so as to form a circuit. As mentioned above, the cathode and anode plates are preferably made from titanium and the anode plates have a non-sacrificial coating, which is a mixed metal oxide, preferably a mixture of iridium oxide and tantalum oxide. The electrocoagulation device preferably includes an exhaust port on a top surface of the housing with the top surface having a generally pyramidal or conical shape and the exhaust port at the top of the pyramid or cone. The electrocoagulation device also includes a drainage port on a bottom of the housing with the bottom of the housing having a generally inverted pyramidal or conical shape with the drainage port on the bottom of the pyramid or cone.

In a particularly preferred embodiment, the air flotation unit may have a generally rectangular processing tank with a contaminated water inlet and a treated water discharge disposed generally opposite the contaminated water inlet. An electrode block is disposed in a bottom of the processing tank and configured so as to be submerged in a fluid contained within the processing tank. A skimming blade is disposed in a top of the processing tank and configured to skim along a fluid surface contained within the processing tank in a direction from the contaminated fluid inlet to the treated water discharge. The skimming blade moves flocculant on the fluid surface in the direction of the treated water outlet. A catch basin is disposed proximate to the treated water outlet and configured so as to receive the flocculant moved by the skimming blade. A sludge discharge port is adjacent to the catch basin and configured to receive the flocculant from the catch basin.

A cavitation aerator may be disposed in the processing vessel proximate to the contaminated water inlet with a cavitation chamber surrounding the cavitation aerator. The electrode block may comprise a plurality of electrode blocks disposed across a width of the processing vessel. Each of the plurality of electrode blocks comprises a plurality of alternating cathode plates and anode plates made of titanium, with the anode plates having a non-sacrificial coating. The non-sacrificial coating comprises a mixed metal oxide, such as a mixture of iridium oxide and tantalum oxide.

A process for treating contaminated fluid includes the steps of cavitating the contaminated fluid in a multi-stage cavitation device, electrocoagulating the cavitated contaminated fluid in an electrocoagulation device, and processing the electrocoagulated contaminated fluid in an air flotation unit producing a sludge outlet and a treated fluid outlet. The process may also include the steps of storing a predetermined quantity of the contaminated fluid in a receiving tank, and pumping the contaminated fluid from the receiving tank to the multi-stage cavitation device. The contaminated fluid may be filtered in a self-cleaning filter apparatus before performing the cavitating step.

The sludge outlet from the air flotation unit may be passed through a filter press producing a dry sludge outlet and filtered fluid outlet. The treated fluid outlet and the filtered fluid outlet are both sent through a final filter, which may comprise a mineral/resin tank or a membrane filter tank.

The electrocoagulating step may include the step of generating oxygen bubbles from a mixed-metal oxide coating on anode plates in the electrocoagulation device. The mixed-metal oxide coating preferably comprises a mixture of iridium oxide and tantalum oxide.

The processing step includes the step of aerating the contaminated fluid using a cavitation aerator. The processing step also includes the step of producing oxygen bubbles from a mixed-metal oxide coating on anode plates in an electrode block disposed in the air flotation unit.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 illustrates the high-throughput cavitation and electrocoagulation apparatus;

FIG. 2 illustrates the high-throughput cavitation and electrocoagulation reactor;

FIG. 3a illustrates a coaxial view of the interelectrode gap indicated by circle 3 in FIG. 2;

FIG. 3b illustrates a coaxial view of an alternate embodiment of the interelectrode gap at circle 3 of FIG. 2;

FIG. 4 illustrates a cross-sectional view of a channel in the inlet sleeve providing access to the interelectrode gap indicated by circle 4 of FIG. 2;

FIGS. 5a and 5b depict photographs of a sample of swamp water before and after processing for purification in the cavitation and electrocoagulation reactor of the present invention;

FIG. 6 depicts a photograph of three portions of a sample of sea water at various stages of separation after processing in a cavitation and electrocoagulation reactor of the present invention;

FIG. 7 is a photograph depicting two samples of natural sources of water illustrating the process of coagulation after treatment in a cavitation and electrocoagulation reactor of the present invention;

FIG. 8 is a schematic illustration of an air flotation and electrocoagulation system according to the present invention;

FIG. 9 is another schematic illustration of the air flotation and electrocoagulation system similar to FIG. 8;

FIG. 10 is a perspective view of an air flotation unit used in the system of the present invention;

FIG. 11 is a reverse perspective view of an air flotation unit used in the system of the present invention;

FIG. 12 is a perspective illustration of an electrocoagulation unit used in the system of the present invention;

FIG. 13 is a perspective view of the electrodes used in the electrocoagulation unit of the present invention;

FIG. 14 is an end view of the electrodes used in the electrocoagulation unit of the present invention;

FIG. 15 is a close-up view of the nut, bolt, and spacers used in the electrodes of the electrocoagulation unit;

FIG. 16 is a perspective view of an array of cathode plates used in the electrocoagulation unit of the present invention;

FIG. 17 is a perspective view of an array of anode plates used in the electrocoagulation unit of the present invention;

FIG. 18 is a perspective view of an air flotation unit including electrode blocks used in the system of the present invention; and

FIG. 19 is a perspective view of a cavitation aerator in the air flotation unit of the present invention.

### DETAILED DESCRIPTION OF THE PREFERRED EMBODIMENTS

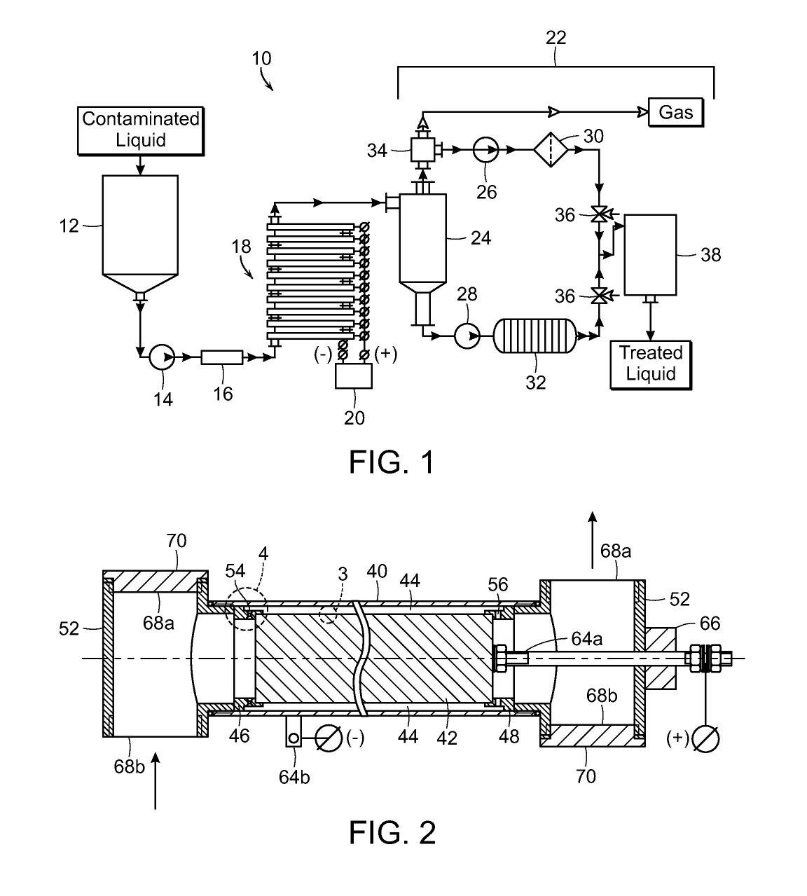

A principal diagram of a possible high-throughput cavitation electrocoagulation system 10 is depicted in FIG. 1. The system 10 is comprised of the several parts that make it possible to efficiently treat contaminated water and remove various contaminants therefrom by using electrocoagulation simultaneously with flow-through hydrodynamic cavitation. The system 10 consists of inlet tank 12, which is filled with fluid to be purified. A high-pressure pump 14 feeds the fluid to a pre-cavitation-generating unit 16 for the cavitation pre-treatment of the fluid. A set of the inventive high-throughput cavitation and electrocoagulation reactors 18 provide the simultaneous application of hydrodynamic cavitation and an electric field, to impose electrochemical, heat and mechanical action on the fluid to be purified. A controlled electrical source with DC output 20 is connected to the reactor 18. A separation system 22 for removal of solid and gaseous flock and debris from the fluid to be purified follows the reactors 18. In this embodiment, the separation system 22 is comprised of a hydraulic cyclone 24, a pump 26 for fluid transfer, a pump 28 for slurry transfer, a fine filter 30, a frame filter 32, a pressure relief pipe 34, back-pressure valves 36 and a tank for the treated water 38.

In the pre-cavitation-generating unit 16, macro vortexes are generated in the fluid flow, which is accompanied by a local pressure decrease to the saturated vapor point of the fluid at the given temperature. When this happens, the proper conditions for the growth of cavitation nuclei in the cavitation bubbles is reached. The formed cavitation bubbles pulse and implode in downstream high-pressure zones. Such action is described in U.S. Pat. No. 7,762,715 and co-pending application Ser. No. 12/464,646, the disclosures of which are incorporated herein.

The inventive high-throughput cavitation and electrocoagulation reactor 18 is shown in the FIG. 2. It is comprised of the hollow cylindrical cathode 40, which hosts the co-axial cylindrical anode 42 forming an interelectrode gap 44 therebetween. The interelectrode gap 44 forms the working chamber of the device 18. An inlet sleeve 46 and an outlet sleeve 48, both made of an electrically insulating material, abut against opposite ends of the anode 42. The electrodes 40, 42 can be made of iron, steel, aluminum, copper, titanium and other metals and their alloys. The surface of the electrodes 40, 42 is preferably covered with a coating, such as mixed metal oxides or other, if required. Both sleeves 46, 48 are installed inside the cathode 40 with the help of cathode inlet fitting 50 and cathode outlet fitting 52, respectively. The inlet sleeve 46 and outlet sleeve 48 electrically insulate the cathode 40 from the anode 42 and physically separate the interelectrode gap 44 from the cathode inlet 50 and cathode outlet 52, respectively.

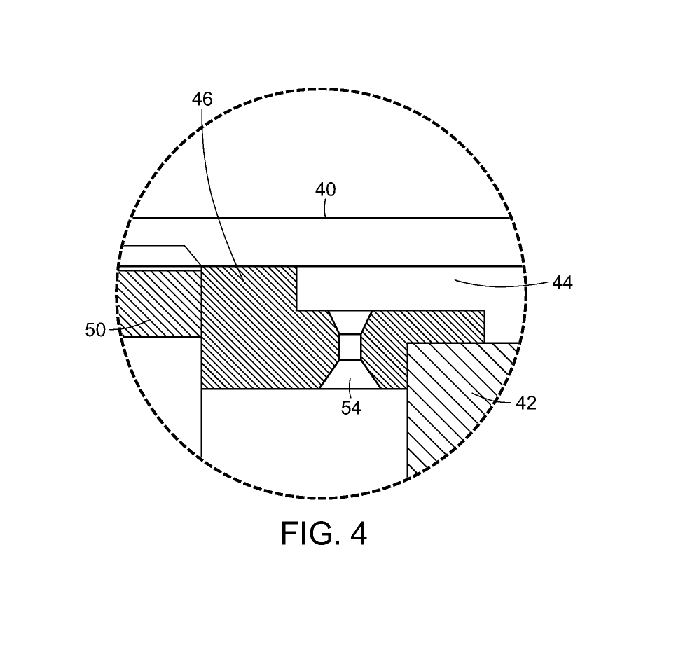

In the inlet sleeve 46, there are a plurality of channels 54 (FIG. 4), which place the cathode inlet 50 in fluid communication with the interelectrode gap 44. The channels 54 have both constrictions and expansions and are radially distributed evenly over the inner surface of the inlet sleeve 46. The channels 54 are preferably implemented in the form of Venturi tubes. The Venturi-type nozzle is a throttle device comprised of a conical inlet with a round profile, a cylindrical throat and a conical diffusor. The unsteady flows generated by the Venturi nozzles can be calculated by those skilled in the art. (Fedotkin and Gulyi, 2000; Mahesh et al., 2004; Li et al., 2008.)

The outlet sleeve 52 is provided with a plurality of cylindrical openings 56, which place the interelectrode gap 44 in fluid communication with the cathode outlet 52. The total cross-sectional area of these cylindrical openings 56 is greater than or equal to the smallest cross-sectional area of the interelectrode gap 44. This requirement must be met to ensure that the hydraulic resistance of the outlet sleeve openings 56 does not exceed that of the interelectrode gap 44.

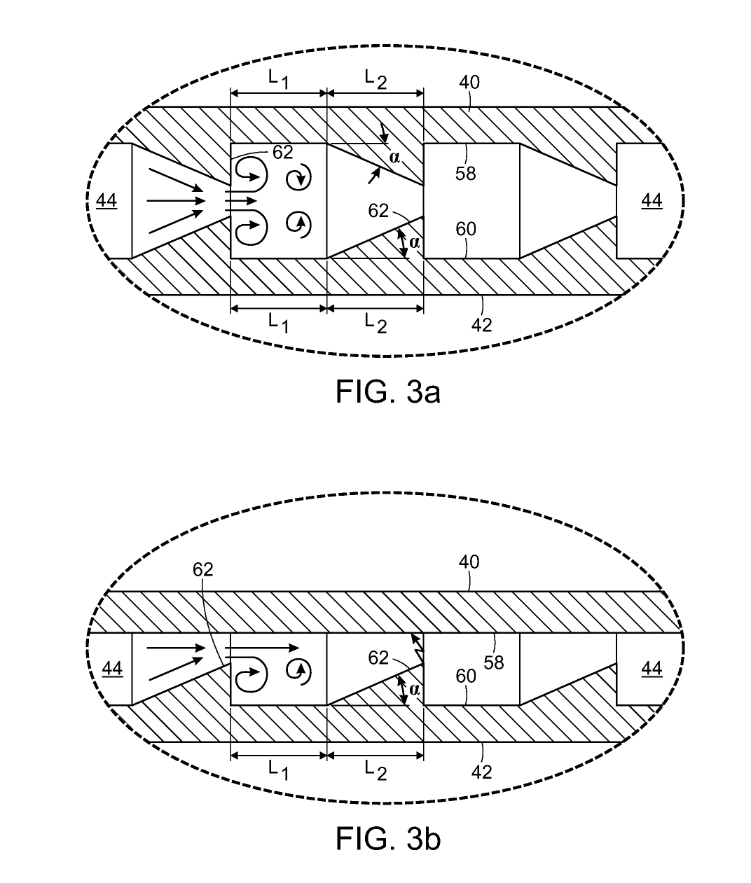

The inner surface 58 of the cathode 40 and/or the outer surface 60 of the anode 42 are provided with patterns or protuberances 62 (FIG. 3a or 3b) that may be thread-like. The patterns 62 are designed to reduce the fluid pressure, resulting in the formation of cavitational features. The electrode surface patterns 62 preferably have rectangular or triangular cross-sections where the long side is parallel to the electrode axis and the short side is perpendicular to the same axis. As illustrated, the angle (α) between the long side and hypotenuse of the triangle is an acute angle, preferably in the range of 15°≦α≦60°. The distance (L1) between the nearest points of neighboring protrusions and the length (L2) of the long side are chosen in accordance with the following condition: 0≦L1/L2≦10.

The cylindrical anode 42 is attached to one terminal of a DC power source 64 that is preferably hosted by the outlet fitting 52 and sealed with a sealing 66. The hollow cathode 40 is connected to the other terminal of the DC power source 64. The inlet and outlet fittings 50, 52 are preferably double-socket, tee-branched flanges having upper and lower ports 68a and 68b. If multiple reactors 18 are connected in a series, then one of the outlet ports 68b and one of the inlet parts 68a are closed with caps 70. If the reactors 18 are assembled in parallel, the cap 70 is absent. A series assembly results in an increase of the processing time and efficiency. A parallel assembly increases the output, resulting in increased processing speed. FIG. 1 illustrates a series assembly.

The inventive flow-through cavitation and electrocoagulation system 10 functions as follows. Fluid to be treated enters the tank 12 and then is transferred by the pump 14 to the pre-cavitation device 16. The cavitation bubbles generated in the fluidic flow pulsate and implode resulting in heat and mass transfer processes and destruction of contaminants and pathogens. The collapse of cavitation bubbles produces enough energy for the dissociation of water molecules followed by the generation of protons, hydroxyl ions, hydroxyl radicals, peroxide and hydrogen molecules. Gas molecules present in these bubbles are excited and followed by multiple energy and charge exchange processes. Oxygen and hydrogen participates in a number of reactions, including the formation of hydroperoxyl radicals, while nitrogen gas may react with the formation of nitrogen dioxide or ammonia. The fluid is then transferred from pre-cavitation device 16 to a plurality of cavitation and electrocoagulation reactors 18, which can be assembled in either series or parallel configuration 3.

FIG. 2 illustrates a single reactor 18, where fluidic flow enters the reactor 18 through the inlet 50 and moves through the channels 54 to the interelectrode gap 44. The channels 54 are provided with the restrictions and the expansions, which aid in generating cavitation. The channels 54 are preferably fabricated in the shape of Venturi-type nozzles to separate vortices and generate pressure pulsations with characteristic frequencies. The fluid leaves the channels 54 and flows through the interelectrode gap 44 formed by the cathode inner surface and anode outer surface.

When the fluid flow moves over electrode surface protrusions 62, additional cavitational features are generated. The cavitation increases the efficiency of the various reactions, i.e., ionization, electrolysis, etc., on the fluid. Since the electrode surfaces 58, 60 are patterned, the width of the interelectrode gap 44 varies along the length of the reactor 18. This creates an uneven electric field along the fluidic flow passage, which causes electrical breakdown and results in an electrohydraulic shock on the fluid. The design of the interelectrode gap 44 provides conditions for alterations in velocity, pressure, voltage and resistance of the fluid flow to improve the efficiency of purification and disinfection of the treated fluid. Cavitation and alternating flow friction also contribute to the clearing and renewal of the electrode surface, preventing passivation. Such actions also heat up the treated fluid. Evolution of oxygen, hydrogen and the cavitation-generated gases improves flotation efficiency and the removal of contaminants by separation processes.

High-intensity cavitation is achieved in the inventive cavitation and electrocoagulation reactor 18 by reducing fluidic flow discharge and increasing the pressure drop between the inlet and outlet reactor sleeves 50, 52. Such fluidic flow discharge of the reactor (Q) is typically a function of the square root of the pressure drop (√ΔP) between the reactor inlet and outlet. An increase in both the concentration and the size of cavitation bubbles decreases the interelectrode cross-sectional area available for fluid flow. As the hydrolytic resistance increases sharply, Q is no longer proportional to the square root of the change in pressure.

After the reactors 18 the fluid moves in a cyclone separator 24. The fluid off the bottom—now a slurry—is pumped with by pump 28 to filter 32, while the gas separator 34 separates gas and the purified fluid, which is transferred by pump 26 to the fine filter 30 and then collected in vessel 38. Because of the cavitation and electrocoagulation processes, the standard separation processes are quicker and more efficient at producing a purified fluid. To prevent overflows the system is equipped with cut-off valves 36.

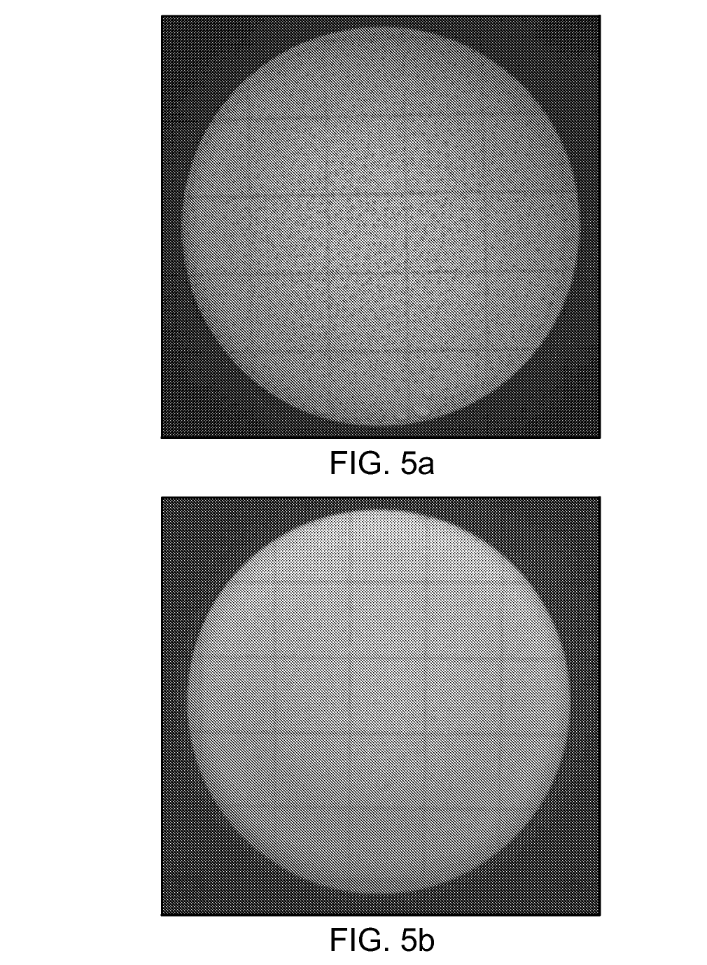

FIGS. 5a and 5b depict photographs of a sample of river/pond water contaminated with E. coli and coliform bacteria both before and after processing in a reactor 18 of the present invention. In both photographs the sample of swamp water is photographed in a 3M® Petrifilm® coliform count plate to facilitate the count of bacteria cells. FIG. 5a illustrates viable cells of contaminants in the water prior to processing. FIG. 5b illustrates the same sample after processing showing a dramatic decrease in the concentration of viable bacterial cells. The sample of water was diluted with tap water in a 1:1 ratio and then processed in the inventive reactor 18 at a rate of ten gallons per minute with electricity supplied at 2-5 volts and 30-60 amperes. Total processing time was one minute. One milliliter of the mixture both before and after processing was pipetted onto the count plate and kept at 30° C. for two days. As can be seen from a comparison of the two images, such processing resulted in complete removal of the bacterial contaminants.

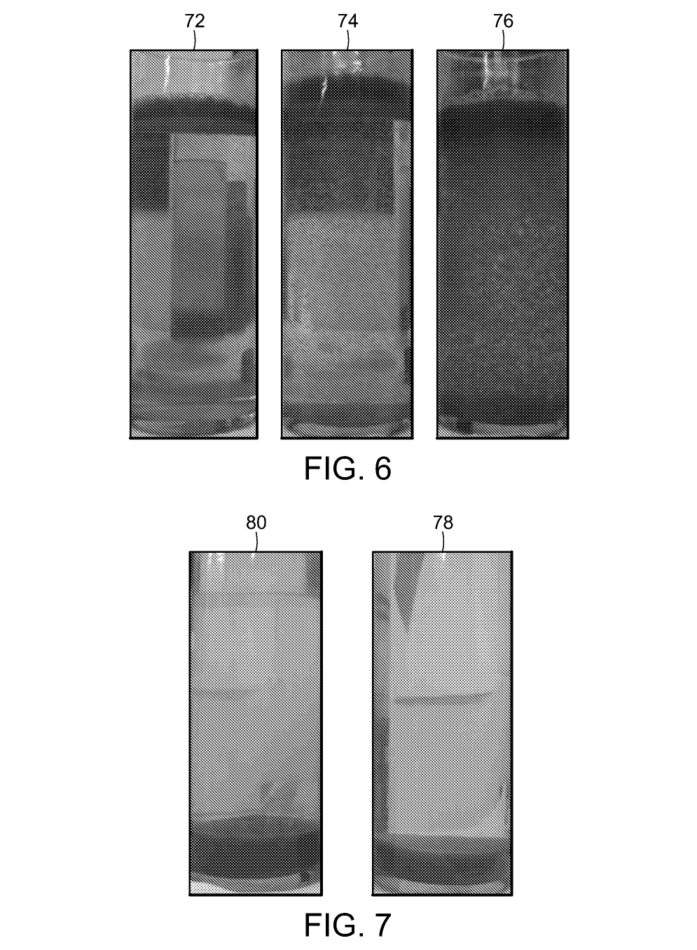

FIG. 6 is a photograph depicting three separate portions of a sample of sea water at different stages of separation after being processed in the inventive reactor 18. The sea water was collected from a pier in Santa Monica, Calif. In the left-most beaker 72, phase separation is essentially complete following processing in the inventive reactor 18. The center beaker 74 contains another portion of the same sample of sea water where separation is approximately half completed. The right-most beaker 76 contains a portion of the same sea water sample immediately after processing in the inventive reactor 18.

FIG. 7 is a photograph depicting two different samples of ocean water. The right-most sample 78 is from a water source containing low levels of contamination, wherein the sample has been processed in the inventive reactor 18. The left-most sample 80 is taken from a water source containing high levels of contamination, wherein the sample has also been processed in the inventive reactor 18. Both samples were passed through the reactor 18 at a rate of ten gallons per minute with electricity supplied at 12 volts and 40-80 amperes. Total processing time for both samples was one minute. No additives or coagulants were introduced in either sample. Such processing resulted in the complete removal of all contaminants, including organic substances and heavy metals.

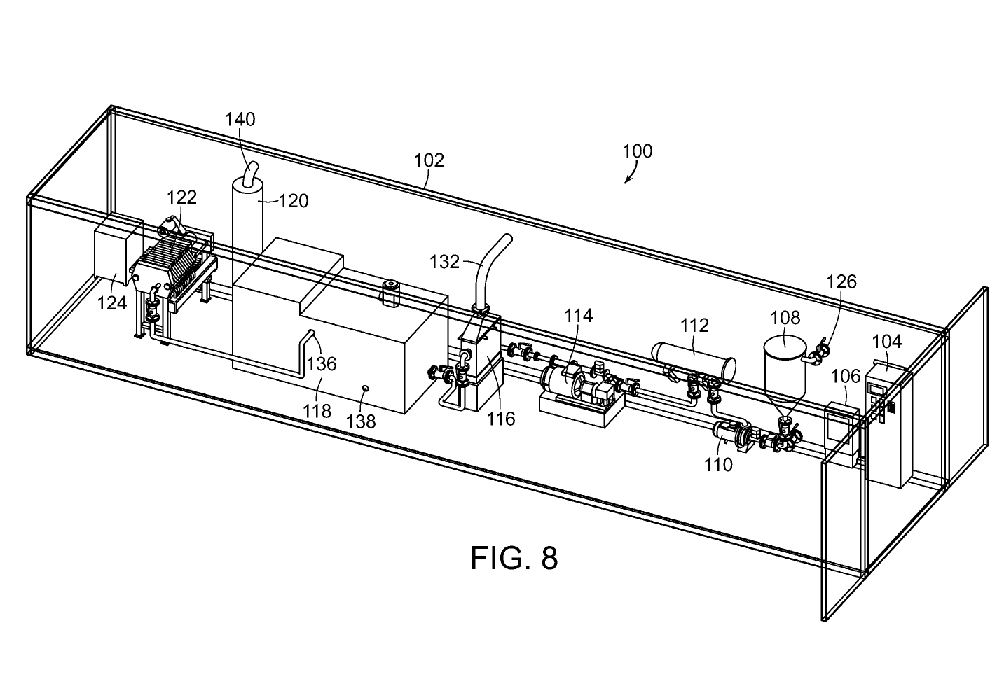

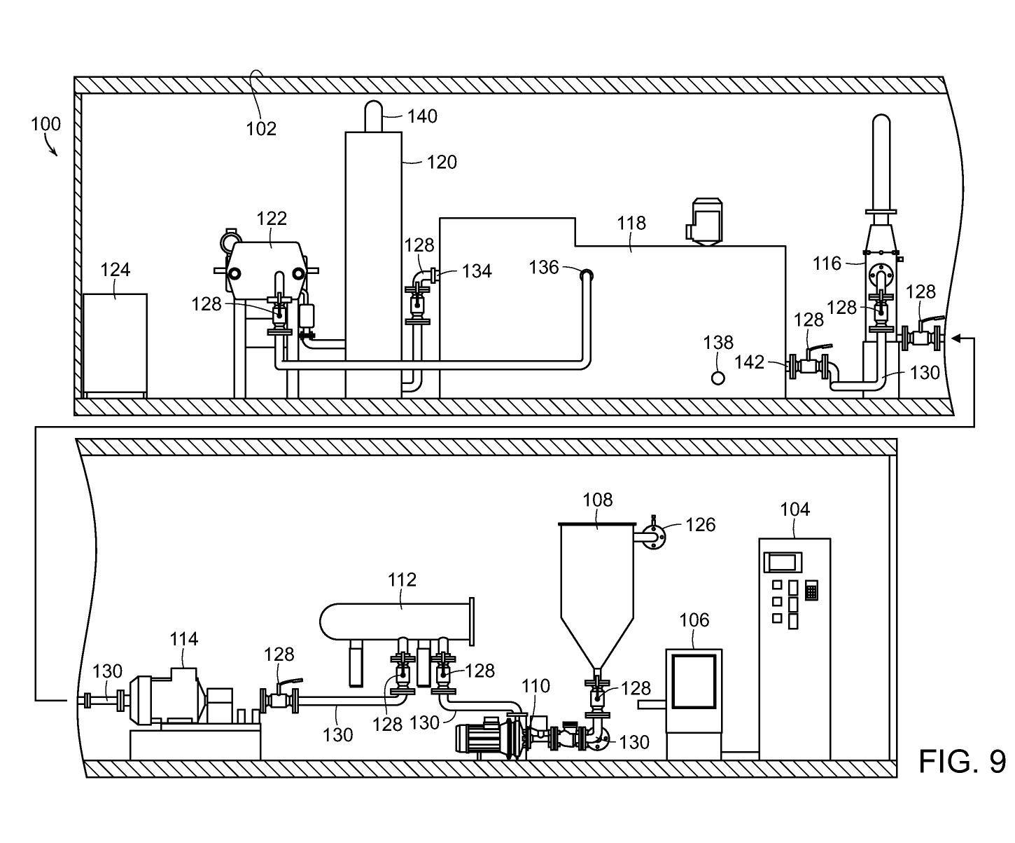

Water purification can have improved results when combined with air flotation processes. FIGS. 8 and 9 illustrate in schematic fashion the air flotation and electrocoagulation system 100 of the present invention. The system 100 is preferably constructed within a shipping container 102 to allow the system 100 to be more easily transported as a single unit. The components of the system 100 are attached to the floor and/or walls of the container 102 with appropriate electrical connections, computer connections and fluid connections. The system 100 includes a computerized control center 104, a rectifier 106, a receiving tank 108, a pump 110, a filter 112, a cavitation unit 114, an electrocoagulation unit 116, an air flotation unit 118, a final filter tank 120, a filter press 122, and a dry sludge collector 124.

The control center 104 provides computer control for the system 100. The control center 104 regulates the opening and closing of various valves throughout the system 100 as well as the flow of electricity to various components. The rectifier 106 is available to convert alternating current into direct current depending upon the requirements of the various components of the system. Each of the primary components from the receiving tank 108 through the filter press 122 are connected by fluid pipes having valves to regulate flow therethrough. Inlet, outlet and exhaust pipes exist throughout the system 100 to introduce fluid, remove product or waste, and permit exhaust where necessary.

The receiving tank 108 is disposed near an inlet 126 into the shipping container 102. The receiving tank 108 receives water to be treated and preferably maintains a minimum volume therein so as to provide a buffer of fluid for the continuous operation of the system 100. The minimum fluid required in the receiving tank 108 to maintain a buffer depends on the flow rate of the fluid through the system 100, which varies from facility to facility. The inlet 126 passes through a wall of the container 102 such that the container may be placed at a field location and hooked directly to a supply of contaminated water to be treated. This allows for on-site treatment of wastewater, such as water resulting from fracking processes, versus the greater expense of hauling the contaminated water to a remote location for treatment.

A valve 128 at the base of the tank regulates flow of fluid out of the tank 108. Piping connects the outlet of the tank 108 to the pump 110. The pump may be any standard pump used in the art for pumping viscous fluids or a mixture of liquids and solids. The pump 110 must be of sufficient design to pump the desired quantity of contaminated fluid through the system 100 reliably and consistently.

The pump 110 forces the fluid into the filter 112, which is preferably a self-cleaning filter. A self-cleaning filter 112 such as that described herein is effective for removing oversized contamination, i.e., ten microns and above, from a contaminated fluid stream. A filter such as that described herein is preferably in-line and the self-cleaning feature eliminates the need for filter bags or cartridges, thus reducing the amount of operator involvement. Such filters 112 also reduce the amount of wastage of filtered fluid. Valves 128 are preferably included on the inlet and outlet of the filter 112.

Piping 130 from the outlet of the filter 112 then leads to the cavitation unit 114. Another valve 128 is positioned at the inlet to the cavitation unit 114. The cavitation unit 114 is preferably a hydrodynamic cavitation device with flow-through capabilities to take advantage of the continuous flow features of the system 100. Although other cavitation devices such as ultrasonic systems may be used, the same typically require batch processing which would reduce the flow-through rate of the system 100 and impede the continuous operation. The cavitation device 114 is preferably a flow-through, hydrodynamic cavitation device of the type described in U.S. Pat. No. 7,762,715 or 8,042,989, the disclosures of which are incorporated herein. The system 100 may also contain a combined cavitation and electrocoagulation unit as described elsewhere herein. Other types of flow-through hydrodynamic cavitation units 114 may also be used in the system.

Prior to processing in the cavitation unit 114, it may be preferable to add certain chemicals or compounds to the treatment fluid in order to alter or modify its properties. For example, if one wanted to increase the conductivity of water sodium hydroxide could be added.

The outlet from the cavitation unit 114 flows through additional piping 130 into the electrocoagulation unit 116. As with the other components a valve 128 is disposed on the inlet of the electrocoagulation unit 116. The outlet of the electrocoagulation unit is connected by piping 130 to the air flotation unit 118. Valves 128 are positioned at the outlet from the electrocoagulation unit 116 and the inlet to the air flotation unit 118. The electrocoagulation unit 116 also includes an exhaust hose 132 to allow gasses and other vapors to escape from the top of the device. The exhaust hose 132 preferably passes through a wall of the container 102 to facilitate connection with a line at the production facility where the system 100 is installed. The specifics of the electrocoagulation unit 116 will be described further below.

The air flotation unit 118 may comprise a dissolved air flotation unit (DAF) as such is known in the art or a cavitated air flotation (CAF) unit as described herein. The specifics of the air flotation unit 118 will be described further below. The air flotation unit 118 has multiple outputs, each including a valve 128 and piping 130 to connect to another component. A treated water outlet 134 is connected to the final filter tank 120. A sludge discharge outlet 136 for material skimmed off the surface is connected to the filter press 122. A heavy sludge discharge 138 allows for removal of material that settles to the bottom of the air flotation unit 118. The material removed from the heavy sludge discharge 138 may simply be removed and disposed of or subject to further processing such as membrane filtration.

The final filter tank 120 receives the treated water discharge from outlet 134 on the air flotation unit 118. The final filter tank 120 acts as a further filtration system before the treated water is discharged from the overall system 100. The final filter tank 120 may be mineral/resin tank or a membrane filter system with both producing similar results.

The filter press 122 includes a valve 128 at its inlet. The filter press 122 receives the flocculant or solids removed from the sludge discharge outlet 134 at the top of the air flotation unit 118 and presses them to extract additional treated water. The liquid outlet from the filter press 122 is sent to the final filter tank 120 and combined with the treated water discharge from the air flotation unit 118 to provide the treated water outlet 140 from the system 100. Plates from the filter press 122 are manually transferred to the dry sludge collector 124 periodically as the filter press requires.

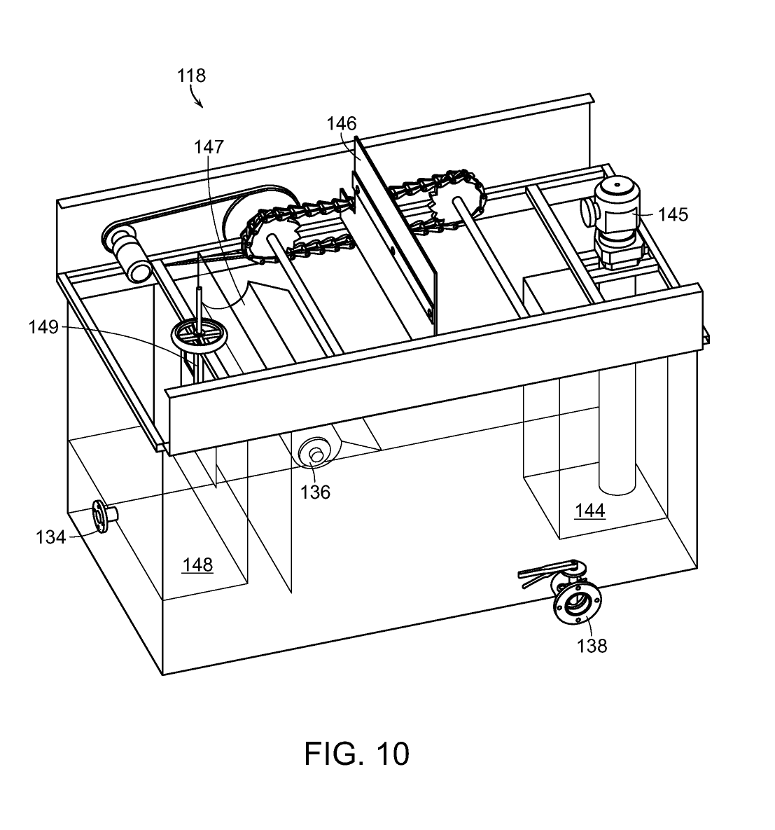

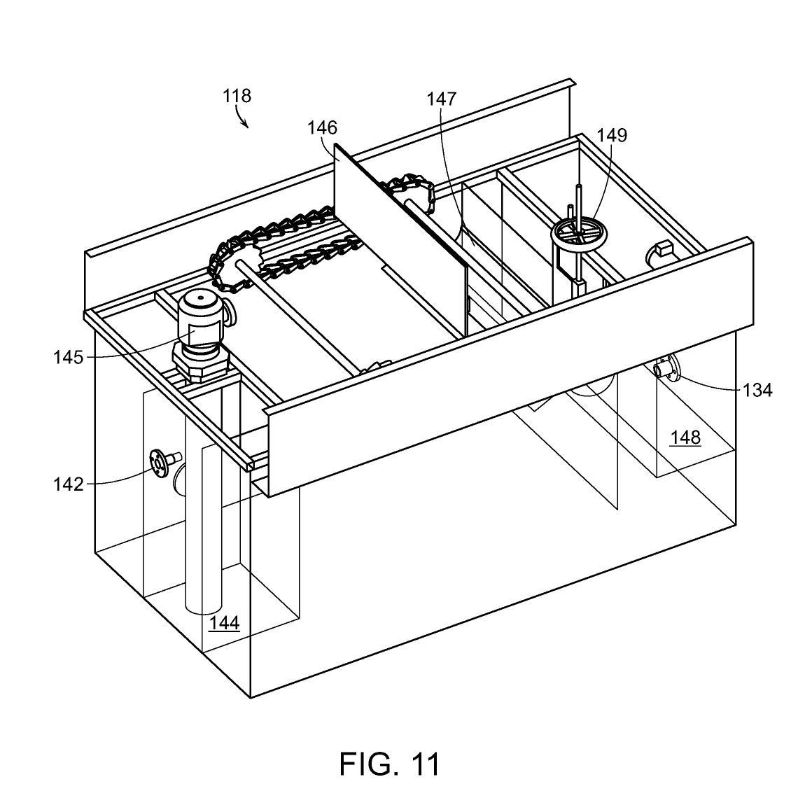

FIGS. 10 and 11 illustrate detailed operation of the air flotation unit 118. The air flotation unit 118 receives the water to be treated through inlet 142. The inlet 142 leads to an aeration chamber 144 including one or more cavitation aerators 145. Operation of the cavitation aerator(s) 145 will be described more fully below. Although the FIGURES only show one aerator, the function and operation of the air flotation unit 118 with multiple cavitation aerators 145 will be similar to that with a single cavitation aerator 145. The addition of multiple cavitation aerators 145 would be necessary for units 118 that are of larger size and processing a larger quantity of treatment fluid. The air flotation unit 118 may be used in water treatment processes for petroleum, petrifaction, textile, food, papermaking, printing, dyeing, fermenting, tannery, slaughter, and industrial water processes, among others.

Fluid leaving the aeration chamber 144 is filled with micro air bubbles having diameters between five microns and fifteen microns. This aerated fluid enters the main chamber of the air flotation unit 118 where the micro air bubbles lift the solids suspended in the fluid and slowly rise to the upper surface where the solids form a flocculant or scum on the surface of the fluid. The micro air bubbles will stay in the fluid for about fifty to sixty seconds. A skimming unit 146 moves the flocculant or scum towards a catch basin 147 near the top of the unit 118. The flocculant or scum in the catch basin 147 is removed through the sludge discharge outlet 136 and processed as described above. Contaminants that do not attach to the micro air bubbles and float to the surface of the fluid settle on the bottom of the unit 118 and are removed through the heavy sludge discharge 138 as described above.

The unit 118 includes a treated water chamber 148 proximate to the treated water outlet 134. A gate valve 149 controls flow of treated water into the chamber 148.

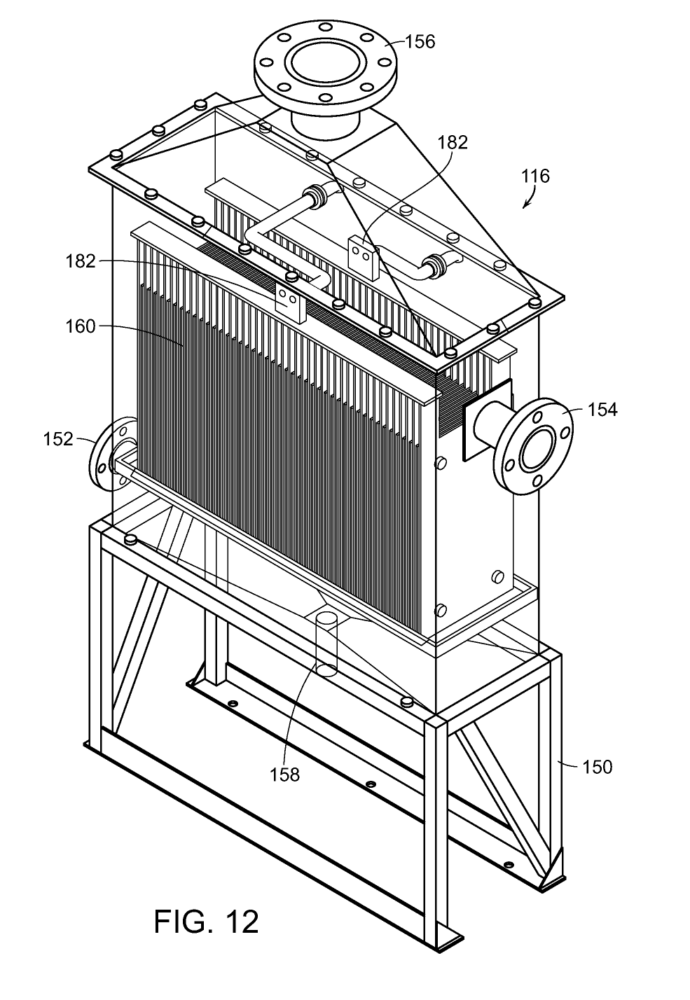

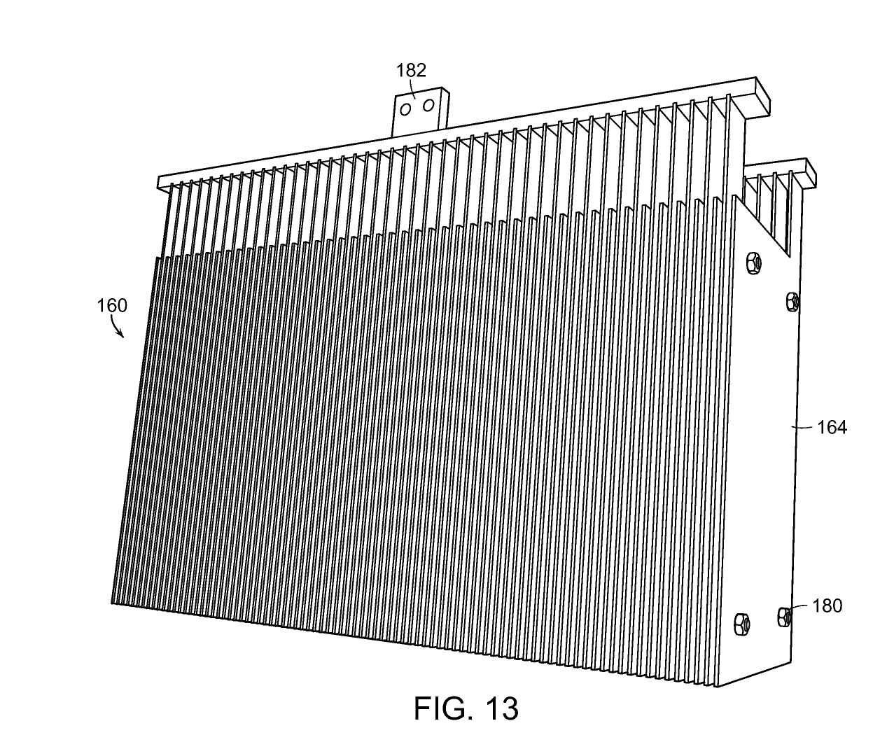

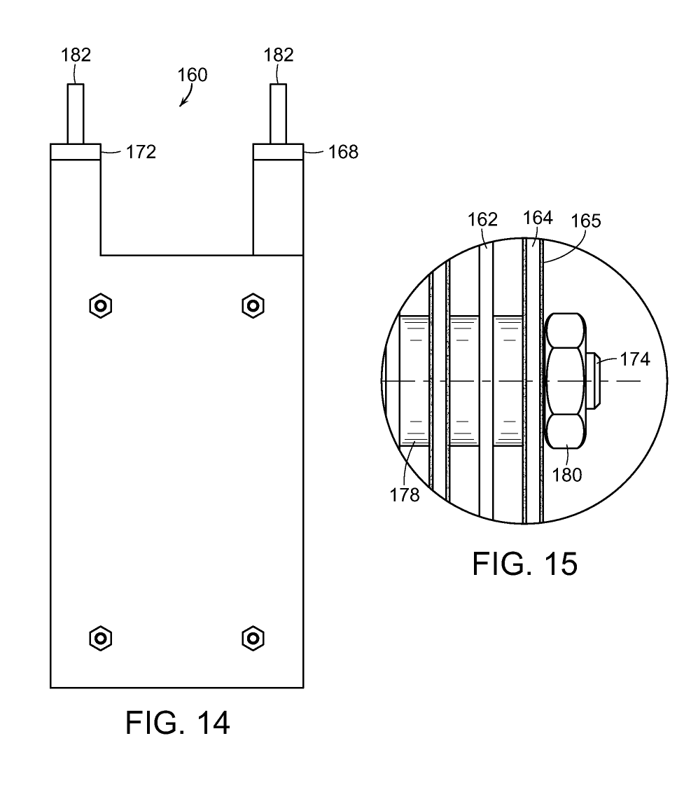

FIGS. 12-17 illustrate the detail of the electrocoagulation device 116. In this embodiment, the device 116 rests on a stand 150 to elevate the device off the floor. The device 116 includes a fluid inlet 152 disposed near a bottom of the device. A fluid outlet 154 is disposed opposite the fluid inlet 152 and generally near an upper portion of the device 116. The top of the device 116 includes an exhaust port 156 configured to release gas and/or vapor from the unit generated during operation. A drainage port 158 may be included on the underside of the device 116. The top and bottom portions of the device 116 preferably have an angled or conical shape to encourage movement or flow towards the respective exhaust port 156 or drainage port 158.

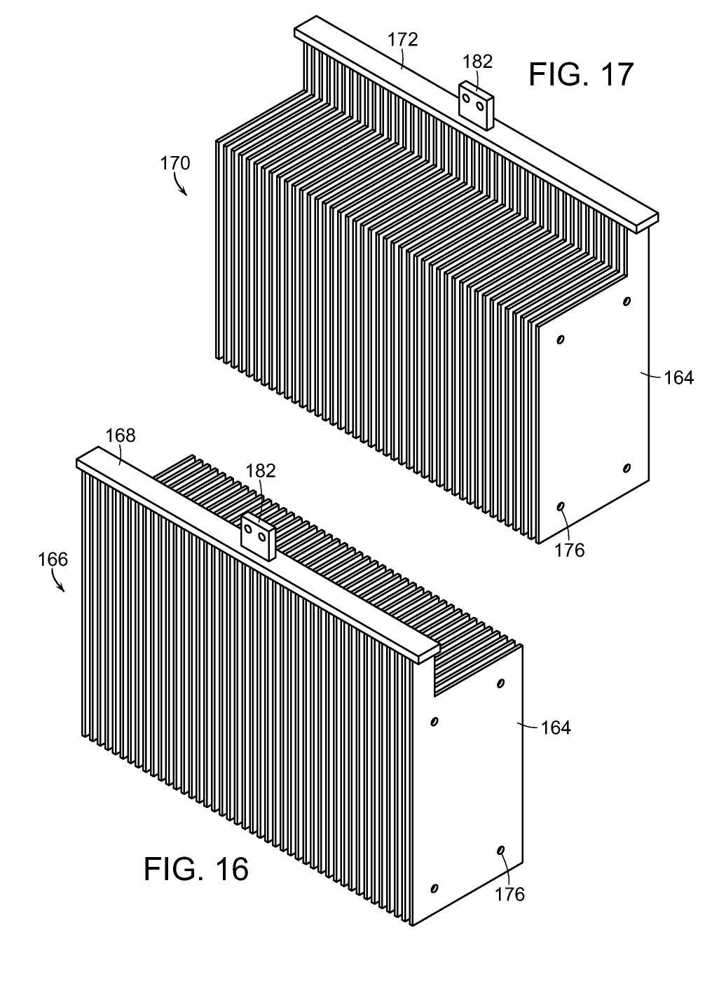

Between the inlet 152 and outlet 154 is a plurality of electrode plates 160. The electrode plates 160 comprise interweaved cathode plates 162 and anode plates 164. The cathode plates 162 are configured in a cathode array 166 (FIG. 16) having a connection block 168 running along the length of the array 166. Each cathode plate 162 is electrically attached to the connection block 168 so as to be configured to receive an electrical charge therefrom.

An anode array 170, depicted in FIG. 17, is constructed similarly to the cathode array 166 including its own connection block 172 to which each of the anode plates 164 in the anode array 170 are electrically attached. The cathode plates 162 of the cathode array 166 are alternatingly interweaved with the anode plates 164 of the anode array 170. In this configuration, each cathode plate 162 is surrounded on both sides by an anode plate 164 and each anode plate 164 is surrounded on both sides by a cathode plate 162, except for the end cathode plate 162 and/or the end anode plate 164.

Once interweaved, the cathode array 166 and anode array 170 are held in place by support rods 174 passed through openings 176 in each of the plates 162, 164. Spacers 178 are disposed between each plate 162, 164 to assure that they do not come in contact yet remain in conductive proximity to each other. A suitable polar distance between the anode plate 164 and cathode plate 162 is about 5 mm to 19 mm. The support rods 174 are secured in place by threaded nuts 180. The support rods, spacers, and threaded nut are preferably non-conductive.

The connection blocks 168, 172 each include a terminal 182 for connection to a corresponding electrical lead. In operation, electricity is conducted into the cathode array 170 where it crosses the gap between the cathode plates 162 and the anode plates 164 and out of the corresponding electrical connection to the anode terminal to complete the electrical circuit. When the device 116 is filled with fluid in the gap between the plates 162, 164, the conducted electricity induces electrocoagulation in the fluid between the plates. The terms cathode and anode have been designated as a convention but the terms may be used interchangeable and electricity may be conducted in the reverse direction as described above without altering the scope of the invention.

The cathode and anode plates 162, 164 may be sacrificial in that their material is depleted over time. In such sacrificial systems, the material of the plates may be spent in as little as one hundred to two hundred hours of operation. In a continuous process such as that described herein, such an electrocoagulation system can quickly become very expensive. The system 100 of the present invention preferably employs an electrocoagulation device 116 that uses non-sacrificial anodes. Specifically, the anode plates 164 are preferably constructed out of titanium having a mixed-metal oxide coating 165 (FIG. 15). The cathode plates 162 may be constructed from stainless steel or titanium and may or may not be coated. The coating material is expensive so the coating may only be applied to the anode for cost savings without loss of efficacy. In FIG. 15, the thickness of the coating 165 relative to the anode plate 164 is exaggerated for clarity of illustration. The coating thickness is preferably in a range from 9 g/m² to 18 g/m².

Various mixed-metal oxides may be used in the coating, but applicants have found that a mixture of iridium oxide (IrO₂) and tantalum oxide(Ta₂O₅) provides particular advantages. In a particularly preferred embodiment, iridium oxide and tantalum oxide are mixed in a ratio of 70 mol % iridium oxide to 30 mol % tantalum oxide. Such a coating makes the anode non-sacrificial such that its titanium material is not depleted as rapidly as non-coated titanium. A coated titanium anode can have a life expectancy ranging anywhere from two to ten years. In addition, four times less energy is required to power the device compared to an aluminum/carbon steel anode. With the coating 165, preferred operating electrical characteristics include voltage from 3 V to 30 V and amperage from 150 A to 300 A.

In the preferred embodiment, the iridium oxide-tantalum oxide coating, particularly in the 70:30 ratio described above, is used because it generates between ten times and one hundred times more oxygen than other mixed-metal oxides in similar electrocoagulation devices. The oxygen generation from the iridium oxide-tantalum oxide coating provides enough oxygen to simulate a dissolved air flotation system within the electrocoagulation device 116. The oxygen bubbles generated by the coated anode have been observed to last from between fifty and sixty seconds.

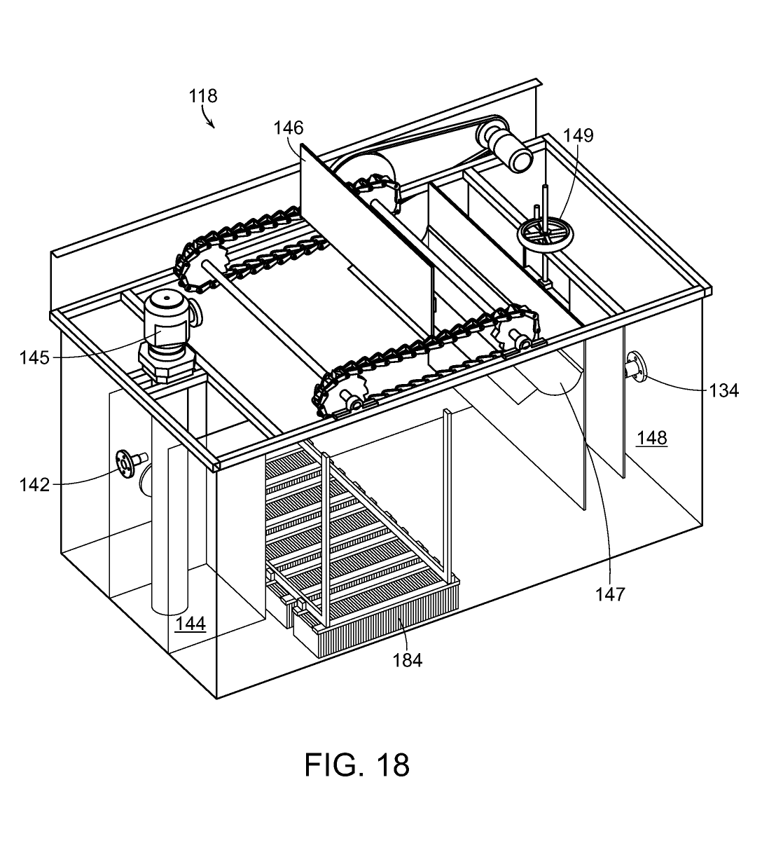

As illustrated in FIG. 18, the air flotation unit 118 may include blocks of electrode plates 184. Each block 184 is preferably constructed by interweaved cathode plates and anode plates as described herein in relation to the electrocoagulation unit 116. The air flotation unit 118 preferably includes a plurality of blocks 184 covering the bottom surface of the unit 118. Each of the plates in the block 184 are preferably constructed of titanium with the anodes bearing a non-sacrificial coating as described. When energized, the blocks 184 generate gas bubbles also as described. The gas bubbles add to the flotation of contaminants, increasing the efficiency of the air flotation unit 118. The number of blocks 184 may vary depending upon the width and flow rate for the unit 118.

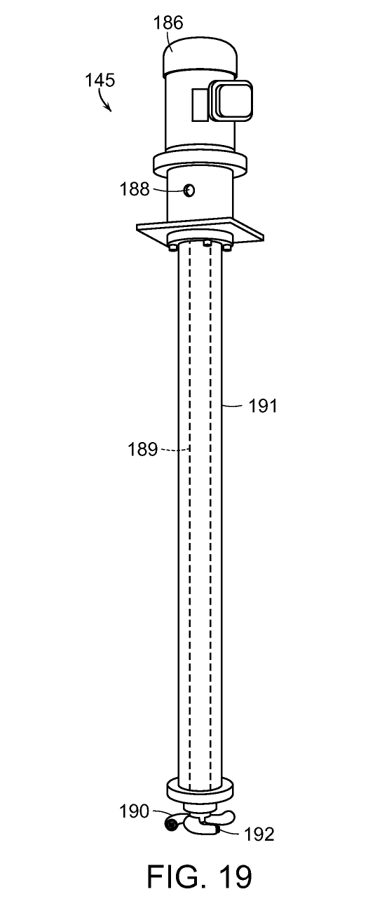

FIG. 19 illustrates the cavitation aerator 145. The cavitation aerator 145 includes a motor 186, an air intake 188, a central drive shaft 189, and air outlet impeller 190. The cavitation aerator 145 spins the impeller 190 at a high speed so as to produce negative pressure and draw air into intake 188. The air drawn into the intake 188 is introduced into the aeration chamber 144 through ports 192 on the air outlet impeller 190. The intake 188 is connected to the ports 192 through the housing 191 that surrounds the drive shaft 189. Appropriate seals are provided to maintain separation between air, liquid, and lubricant. The high speed of the impeller 190 imparts a strong flow on the fluid within the chamber 144 which fluid is combined with the air released from the ports 192 on the impeller 190. Such action simulates cavitation processes and introduces micro air bubbles having diameters between five microns and fifteen microns as described above. Such micro air bubbles will preferably remain in the fluid for about fifty to sixty seconds. The cavitation aerator 145 has the advantage of providing a big aeration volume and micro air bubbles having a fast rise speed in the air flotation unit 118. The cavitation aerator 145 also has simple maintenance, low energy consumption, low noise, long service life, and eliminates the need for an air compressor or dissolved air tank as may be found in typical dissolved air flotation units.

While various embodiments have been shown and described, it will be understood that there is no intent to limit the invention by such disclosure, but rather is intended to cover all modifications and alternate constructions falling within the spirit and scope of the present invention. The examples are given for illustrating the present invention and should not be construed as limitations on the scope or spirit of the invention. Accordingly, the scope of the present invention should be determined solely by the appended claims and their legal equivalents, rather than by the examples given.

What is claimed is:

1. An electrocoagulation device comprising:
an enclosed housing having a fluid inlet and a fluid outlet;
a plurality of alternating cathode plates and anode plates disposed between the fluid inlet and the fluid outlet;
an electrical source connected on a first side to the cathode plates and on a second side to the anode plates so as to form a circuit; and
wherein the anode plates have a non-sacrificial coating.

2. The electrocoagulation device of claim 1, wherein the cathode plates and the anode plates are made of titanium and wherein the non-sacrificial coating comprises a mixed metal oxide.

3. The electrocoagulation device of claim 2, wherein the mixed metal oxide comprises iridium oxide and tantalum oxide.

4. The electrocoagulation device of claim 1, further comprising an exhaust port on a top surface of the housing.

5. The electrocoagulation device of claim 4, wherein the top surface of the housing has a generally pyramidal or conical shape and the exhaust port is at the top of the pyramid or cone.

6. The electrocoagulation device of claim 1, further comprising a drainage port on a bottom of the housing.

7. The electrocoagulation device of claim 6, wherein the bottom of the housing has a generally inverted pyramidal or conical shape with the drainage port on the bottom of the pyramid or cone.

8. An air flotation unit, comprising:
a generally rectangular processing tank having a contaminated water inlet and a treated water discharge disposed generally opposite the contaminated water inlet;
an electrode block disposed in a bottom of the processing tank configured so as to be submerged in a fluid contained within the processing tank;
a skimming blade disposed in a top of the processing tank, the skimming blade configured to skim along a fluid surface within the processing tank and move flocculant on the fluid surface in the direction of the treated water outlet;
a catch basin disposed proximate to the fluid surface and configured so as to receive the flocculant moved by the skimming blade; and
a sludge discharge port adjacent to the catch basin configured to receive the flocculant from the catch basin.

9. The air flotation unit of claim 8, further comprising a cavitation aerator disposed proximate to the contaminated water inlet and a cavitation chamber surrounding the cavitation aerator.

10. The air flotation unit of claim 8, wherein the electrode block comprises a plurality of electrode blocks disposed across a width of the processing vessel.

11. The air flotation unit of claim 10, wherein each of the plurality of electrode blocks comprises a plurality of alternating cathode plates and anode plates.

12. The air flotation unit of claim 11, wherein the cathode plates and anode plates are made of titanium and wherein the anode plates have a non-sacrificial coating.

13. The air flotation unit of claim 12, wherein the non-sacrificial coating comprises a mixed metal oxide.

14. The air flotation unit of claim 13, wherein the mixed metal oxide comprises iridium oxide and tantalum oxide.

15. A fluid treatment system configured for essentially continuous operation, the system comprising:
a pump configured to force a contaminated fluid through the system;
a multi-stage cavitation system fluidly connected to a fluid discharge from the pump;
an electrocoagulation device fluidly connected to a fluid outlet from the multi-stage cavitation system; and
an air flotation unit fluidly connected to a fluid outlet from the electrocoagulation device.

16. The fluid treatment system of claim 15, further comprising a receiving tank configured to receive and store fluid for treatment, wherein the receiving tank is disposed upstream of the pump and fluidly connected to a fluid inlet on the pump.

17. The fluid treatment system of claim 15, further comprising a self-cleaning filter fluidly connected to the fluid discharge from the pump and configured to pass filtered contaminated fluid to the multi-stage cavitation system.

18. The fluid treatment system of claim 15, further comprising a final filter tank fluidly connected to a treated fluid outlet from the air flotation unit.

19. The fluid treatment system of claim 18, further comprising a filter press fluidly connected to a sludge discharge from the air flotation unit and a fluid outlet from the filter press fluidly connected to the final filter tank.

20. The fluid treatment system of claim 18, wherein the final filter tank comprises a mineral/resin tank or a membrane filter tank.

21. The fluid treatment system of claim 15, wherein the multi-stage cavitation system comprises a plurality of multi-stage cavitation devices, connected in series or in parallel.

22. The fluid treatment system of claim 15, wherein the electrocoagulation device comprises a plurality of alternating cathode and anode plates made from titanium.

23. The fluid treatment system of claim 22, wherein the anode plates are non-sacrificial and have a mixed-metal oxide coating.

24. The fluid treatment system of claim 23, wherein the mixed-metal oxide coating comprises iridium oxide and tantalum oxide.

25. The fluid treatment system of claim 15, wherein the air flotation unit comprises an electrode block, the electrode block comprising a plurality of alternating cathode and anode plates made from titanium.

26. The fluid treatment system of claim 25, wherein the anode plates are non-sacrificial and include a mixed-metal oxide coating.

27. The fluid treatment system of claim 26, wherein the mixed-metal oxide coating comprises iridium oxide and tantalum oxide.

28. A process for treating contaminated fluid, comprising the steps of:
cavitating the contaminated fluid in a multi-stage cavitation device;
electrocoagulating the cavitated contaminated fluid in an electrocoagulation device; and
processing the electrocoagulated contaminated fluid in an air flotation unit producing a sludge outlet and a treated fluid outlet.

29. The process of claim 28, further comprising the steps of:
storing a predetermined quantity of the contaminated fluid in a receiving tank; and
pumping the contaminated fluid from the receiving tank to the multi-stage cavitation device.

30. The process of claim 28, further comprising the step of filtering the contaminated fluid in a self-cleaning filter apparatus before performing the cavitating step.

31. The process of claim 28, further comprising the step of passing the sludge outlet from the air flotation unit through a filter press producing a dry sludge outlet and filtered fluid outlet.

32. The process of claim 31, further comprising the step of sending the treated fluid outlet and the filtered fluid outlet through a final filter.

33. The process of claim 32, wherein the final filter comprises a mineral/resin tank or a membrane filter.

34. The process of claim 28, wherein the electrocoagulating step includes the step of generating oxygen bubbles from a mixed-metal oxide coating on anode plates in the electrocoagulation device.

35. The process of claim 34, wherein the mixed-metal oxide coating comprises iridium oxide and tantalum oxide.

36. The process of claim 28, wherein the processing step includes the step of aerating the contaminated fluid using a cavitation aerator.

37. The process of claim 28, wherein the processing step includes the step of producing oxygen bubbles from a mixed-metal oxide coating on anode plates in an electrode block disposed in the air flotation unit.
